(19) United States
(12) Patent Application Publication
(10) Pub. No.: US 2026/0165443 A1
(43) Pub. Date: Jun. 18, 2026

(54) METHOD FOR MANUFACTURING COSMETIC APPLICATOR

(71) Applicant: David C. CHUNG, Incheon (KR)

(72) Inventor: David C. CHUNG, Incheon (KR)

(21) Appl. No.: 19/330,144

(22) Filed: Sep. 16, 2025

(30) Foreign Application Priority Data
Dec. 16, 2024 (KR) 10-2024-0187505

(51) Int. Cl. A45D 34/04; A45D 40/26; B29D 99/00; B29K 75/00

(52) U.S. Cl. CPC A45D 34/04; A45D 40/26; B29D 99/0003; A45D 2200/1018; B29K 2075/00; B29K 2995/007

(57) ABSTRACT

A method for manufacturing a cosmetic applicator that includes the steps of: (a) preparing a mold having a solid shape engraved therein; (b) allowing a first film to come into close contact with the inner surface of the mold; (c) filling a filler in the mold; (d) allowing a second film to come into close contact with the mold to thus bond the first film and the second film to each other; (e) cutting the first film and the second film to make a soft part; and (f) joining a support part to the second film.

### CROSS REFERENCE TO RELATED APPLICATION OF THE DISCLOSURE

The present application claims the priority and benefit of Korean Patent Application No. 10-2024-0187505 filed in the Korean Intellectual Property Office on Dec. 16, 2024, the entire contents of which are incorporated herein by reference.

### BACKGROUND OF THE DISCLOSURE

### Field of the Disclosure

The present disclosure relates to a method for manufacturing a cosmetic applicator, more particularly to a method for manufacturing a cosmetic applicator that is capable of allowing the cosmetic applicator to be equipped with a soft part for applying a cosmetic smoothly.

### Background of the Related Art

In modern societies, cosmetics are essential in enhancing an individual's appearance and boosting his or her confidence, and to use the cosmetics more conveniently and sanitarily, a variety of tools and techniques for applying the cosmetics to a desired place have been developed. To use a cosmetic, generally, the cosmetic is first taken off to a user's hand and then applied to his or her face or skin. In this case, since the cosmetic may remain on the hand, he or she has to wash his or her hand inconveniently to remove the cosmetic, and further, the cosmetic is wasted unnecessarily. To solve such problems, the cosmetic is applied to the skin through an applicator, not through the hand.

In the case of an existing applicator, an application part is made of a hard material so that when it comes into close contact with the skin, it has poor cushioning and expresses a low degree of skin contact. When a cosmetic is applied to the skin through the applicator, besides, the hard material of the application part fails to spread the cosmetic uniformly on the skin, thereby disadvantageously providing a bad feeling of use. To solve such problems, an applicator, which is made of a soft material that imitates a hand's touch to provide smooth spreadability, has been developed.

However, the applicator containing the soft material is hard to apply molding techniques (e.g., injection molding, extrusion molding, blow molding, etc.) using molds thereto. If a mold with an asymmetrical solid shape engraved therein is used, further, a material filled in the mold is not uniform in pattern to cause a product to become deteriorated in quality, and the internal stress in the mold is not regular in distribution, thereby lowering the durability and strength of the applicator. Therefore, it is difficult to make the existing applicator containing the soft material through the mold that is not regular in depth, so that it is hard to design a tilt surface or to obtain an asymmetrical structure on the applicator, which causes many limitations in designing the applicator.

In the case of the applicator containing the soft material, moreover, the soft material is first molded, and next, the molded soft material is coupled to an injection molded part, thereby causing a complicated manufacturing process and increasing a manufacturing cost.

To overcome such problems, the present inventor has studied a method for manufacturing a cosmetic applicator that can enhance a degree of freedom in designing the cosmetic applicator and manufacturing the cosmetic applicator efficiently. As a result, the present inventor has suggested a method for manufacturing a cosmetic applicator that allows the cosmetic applicator to be made using a mold with an asymmetrical solid shape engraved therein and has a process of joining a soft material and a hard material by means of welding, thereby enhancing an efficiency in manufacturing the cosmetic applicator.

### SUMMARY OF THE DISCLOSURE

Accordingly, the present disclosure has been made in view of the above-mentioned problems occurring in the related art, and it is an object of the present disclosure to provide a method for manufacturing a cosmetic applicator that is capable of enhancing a degree of freedom in designing a soft part of the cosmetic applicator and providing an excellent efficiency in manufacturing the cosmetic applicator.

To accomplish the above-mentioned objects, according to one aspect of the present disclosure, there is provided a method for manufacturing a cosmetic applicator that may include the steps of: (a) preparing a mold having a solid shape engraved therein; (b) allowing a first film to come into close contact with the inner surface of the mold; (c) filling a filler into the mold; (d) allowing a second film to come into close contact with the mold to thus bond the first film and the second film to each other; (e) cutting the first film and the second film to make a soft part; and (f) joining a support part to the second film.

In an embodiment, the solid shape may have a surface tilting in one direction.

In an embodiment, in the step of (b), the close contact may be performed by means of vacuum suction.

In an embodiment, the first film may contain thermoplastic polyurethane (TPU).

In an embodiment, the first film may have a thickness between 30 and 70 μm.

In an embodiment, the filler may be at least one of silicone, polyurethan (PU), polyethylene (PE), and thermoplastic elastomer (TPE).

In an embodiment, the second film may contain thermoplastic polyurethane (TPU).

In an embodiment, the second film may have a thickness between 80 and 120 μm.

In an embodiment, in the step of (f), the joining may be performed by means of ultrasonic welding.

In an embodiment, the support part may contain the same material as the second film.

In an embodiment, if the support part may have a through hole, a hollow hole may be formed by cutting the first film and the second film in the step of (e), and a diameter of the hollow hole may be greater than a diameter of the through hole formed on the support part.

To accomplish the above-mentioned objects, according to another aspect of the present disclosure, there is provided a cosmetic applicator that may be manufactured according to the above-mentioned method.

To accomplish the above-mentioned objects, according to yet another aspect of the present disclosure, there is provided a cosmetic applicator including: a soft part having a first film, a filler, and a second film; and a support part, wherein the first film may be bonded to one surface of the filler, the second film may be bonded to the other surface of the filler, the support part may be joined to the other surface of the soft part, and the soft part may have an application surface formed on one surface thereof in such a way as to tilt in one direction.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a cosmetic applicator according to the present disclosure;

FIG. 2 is a flowchart showing a method for manufacturing a cosmetic applicator according to the present disclosure;

FIGS. 3A to 3F are sectional views showing the method for manufacturing a cosmetic applicator according to the present disclosure; and

FIG. 4 is a sectional view showing the step of cutting films if a through hole is formed on a support part in the method for manufacturing a cosmetic applicator according to the present disclosure.

### DETAILED DESCRIPTION OF THE EMBODIMENTS

Hereinafter, exemplary embodiments of the present disclosure will be described in detail below with reference to the accompanying drawings. In order to facilitate the general understanding of the present disclosure in describing the present disclosure, through the accompanying drawings, the same reference numerals will be used to describe the same components and an overlapped description of the same components will be omitted. In the description of the present disclosure, it should be understood that up, down, left and right directions are based on the attached drawings, which are conveniently used only to briefly explain the present disclosure, and therefore, the present disclosure may not be limited by the above-mentioned directions.

Terms, such as the first, the second, A, and B, may be used to describe various elements, but the elements should not be restricted by the terms. The terms are used to only distinguish one element from the other element. For example, a first element may be named a second element without departing from the scope of the present disclosure. Likewise, a second element may be named a first element. A term ‘and/or’ includes a combination of a plurality of relevant and described items or any one of a plurality of related and described items.

Terms used in this application are used to only describe specific exemplary embodiments and are not intended to restrict the present disclosure. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

As used herein, when an element is described as being “connected” or “coupled” to another element, the element may be directly connected or coupled to the other element, or one or more intervening elements may be present. In addition, when a part is described as “including” a component, this should not be construed as excluding other components, unless explicitly stated otherwise, and may further include additional components.

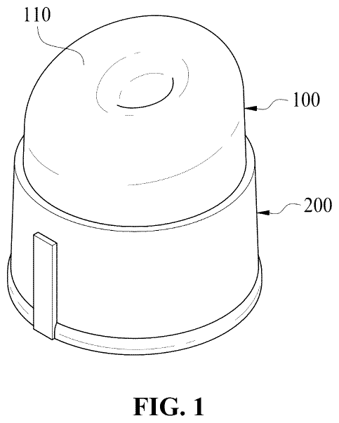

FIG. 1 is a perspective view showing a cosmetic applicator according to the present disclosure.

Referring to FIG. 1, a cosmetic applicator according to the present disclosure includes a soft part 100 and a support part 200.

The soft part 100 is an area to be brought into close contact with a user's skin and contains a soft material. The soft material means a material providing smooth application for the skin. For example, the soft material has given elasticity or restoring force returning to its original shape when pressed.

The soft part 100 is freely shaped. For example, the soft part 100 has an application surface 110 formed on one surface thereof in such a way as to tilt in one direction for the smooth cosmetic application. Otherwise, the soft part 100 has a through hole as a path along which a cosmetic is discharged.

The support part 200 is configured to fix and support the soft part 100 thereto and contains a hard material. The support part 200 serves as a coupling part coupled to a cosmetic container, while reinforcing the physical properties of the soft part 100.

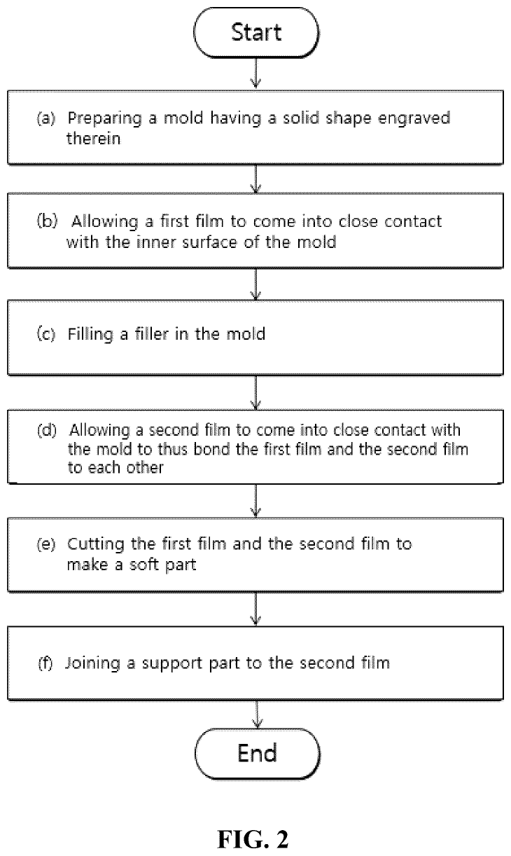

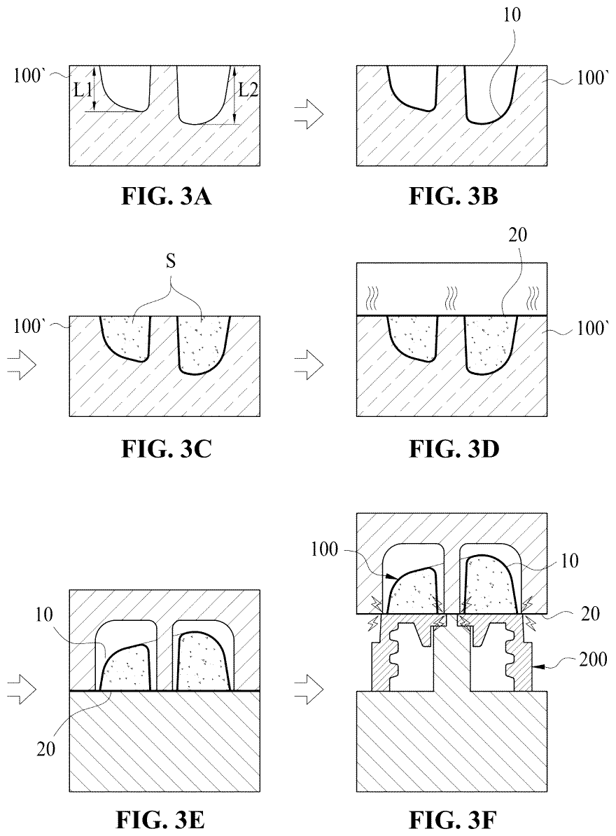

FIG. 2 is a flowchart showing a method for manufacturing a cosmetic applicator according to the present disclosure, and FIGS. 3A to 3F are sectional views showing the method for manufacturing a cosmetic applicator according to the present disclosure.

Referring to FIGS. 2 to 3F, a method for manufacturing a cosmetic applicator according to the present disclosure includes the steps of: (a) preparing a mold 100′ having a solid shape engraved therein; (b) allowing a first film 10 to come into close contact with the inner surface of the mold 100′; (c) filling a filler S in the mold; (d) allowing a second film 20 to come into close contact with the mold 100′ and then bonding the first film 10 and the second film 20 to each other; (e) cutting the first film 10 and the second film 20 to make a soft part 100; and (f) joining a support part 200 to the second film 20.

To make the soft part 100 of the cosmetic applicator, first, the mold 100′ having the solid shape engraved therein is prepared (in the step of (a)).

The solid shape engraved in the mold 100′ is a space in which the soft part 100 of the cosmetic applicator is molded. Therefore, the solid shape is the same as a desired shape of the soft part 100 of the cosmetic applicator.

The solid shape engraved in the mold 100′ is formed to have various structures capable of accomplishing the object of the present disclosure that can improve the feeling of use of the soft part 100.

According to the present disclosure, the solid shape engraved in the mold 100′ is asymmetrical in section. If a mold having an asymmetrical solid shape engraved therein is used in conventional practices, a filled pattern of a material in the mold is not uniform, thereby making a quality of a product deteriorated, and further, stress distribution in the mold is not even, thereby lowering durability and strength of the product. According to the present disclosure, however, the soft part 100 with good durability can be made through the mold 100′ with an irregular depth, thereby making it possible to manufacture various types of cosmetic applicators.

According to an embodiment of the present disclosure, a first depth L1 and a second depth L2 that are vertical to the inner surface of the mold 100′ from the top surface thereof are different from each other on the asymmetrical surface of the mold 100′ on the sectional view of the mold 100′.

According to an embodiment of the present disclosure, the solid shape engraved in the mold 100′ has a tilting surface on one surface thereof in one direction or has an asymmetrical donut shape having a through hole along which a fluid is discharged.

Next, the first film 10 comes into close contact with the inner surface of the mold 100′ having the solid shape of the soft part 100 engraved therein (in the step of (b)).

In the process of allowing the first film 10 to come into close contact with the inner surface of the mold 100′, if the solid shape engraved in the mold 100′ is asymmetrical, differences in the degree of elongation of the first film 10 are made according to positions with which the first film 10 comes into close contact, thereby causing the first film 10 to be wrinkled or torn.

To solve such problems, the first film 10 evenly comes into close contact with the inner surface of the mold 100′ by means of vacuum suction.

In a state where air is removed out of the interior of the mold 100′ to form a vacuum state in the mold 100′, in detail, the process of allowing the first film 10 to come into close contact with the inner surface of the mold 100′ is performed, so that the first film 10 is brought into close contact with the inner surface of the mold 100′ smoothly, without having bubble marks or wrinkles occurring between the first film 10 and the inner surface of the mold 100′ due to the air existing in the mold 100′. Further, the first film 10 is brought into close contact with the inner surface of the mold 100′ within a short period of time by means of the vacuum suction, thereby reducing the total process time and improving the productivity.

The first film 10 serves to protect the filler S that is going to be filled in the mold 100′ in a post process and thus keep the shape of the filler S.

According to an embodiment of the present disclosure, the first film 10 contains thermoplastic polyurethane (TPU).

The TPU is a material that is soft and exhibits high chemical resistance, high abrasion resistance, high heat resistance, and high durability, thereby protecting the filler S filled in the soft part 100 and keeping the shape of the filler S.

According to an embodiment of the present disclosure, the first film 10 has a thickness between 30 and 70 μm, especially between 35 and 65 μm, more especially between 40 and 60 μm. If the thickness of the first film 10 is less than the above lower limit value, it is hard to achieve foaming of the first film 10, and further, a portion of the first film 10 becomes excessively thin and melted in a post process using heat. If the thickness of the first film 10 is over the above upper limit value, the first film 10 becomes excessively soft in texture.

Next, the filler S is filled in the mold 100′ in the state where the first film 10 is brought into close contact with the inner surface of the mold 100′ (in the step of (c)).

The filler S has liquidity and thus flows to the front side of the solid shape engraved in the mold 100′. To ensure the liquidity of the filler S, the mold 100′ is kept at a temperature higher than a solidification temperature (e.g., crystallization temperature or glass transition temperature) of the filler S.

According to an embodiment of the present disclosure, the filler S is at least one of silicone, polyurethan (PU), polyethylene (PE), and thermoplastic elastomer (TPE). Such a soft material is filled in the mold 100′ in a state of being softened, and next, the soft material becomes hardened. As the filing material S is made of the soft material, the soft part 100 coming into close contact with the skin becomes elastic and provides smooth skin contact.

The second film 20 comes into close contact with the mold 100′ in which the filler S is filled, and next, the first film 10 and the second film 20 are bonded to each other (in the step of (d)).

A process of bonding the first film 10 and the second film 20 is performed using any one or more methods selected from heat, pressure, ultrasound, laser, and solvent. In detail, the first film 10 and the second film 20 are bonded by means of thermal bonding or thermal pressure bonding to seal the filler S.

According to an embodiment of the present disclosure, a lower mold plate is used as the mold with the solid shape of the soft part 100, and next, an upper mold plate is placed on top of the lower mold plate. After that, a temperature of any one of the upper mold plate and the lower mold plate increases by means of the thermal bonding or thermal pressure bonding, thereby bonding the first film 10 and the second film 20 to each other.

The second film 20 serves to protect the filler S filled in the mold 100′ and thus keep the shape of the filler S.

According to an embodiment of the present disclosure, the second film 20 contains thermoplastic polyurethane (TPU).

The TPU is a material that exhibits high flexibility and durability, and if the second film 20 contains TPU, it protects the filler S filled in the soft part 100 and keeps the shape of the filler S.

In this case, if the first film 10 and the second film 20 of the soft part 10 contain the same material, they are firmly bonded to each other to improve the durability of the soft part 100. In detail, the first film 10 and the second film 20 contain TPU.

According to an embodiment of the present disclosure, the second film 20 has a thickness between 80 and 120 μm, especially between 85 and 115 μm, more especially between 90 and 110 μm. If the thickness of the second film 20 is less than the above lower limit value, the second film 20 may be damaged or broken in a process of joining the support part 200 thereto by means of ultrasonic welding. If the thickness of the second film 20 is over the above upper limit value, contrarily, ultrasonic energy transmission to the second film 20 becomes weakened, thereby making it hard to join the support part 200 to the second film 20 by means of ultrasonic welding.

According to an embodiment of the present disclosure, in a state where the first film 10 faces one surface of the second film 20 and a release film faces the other surface of the second film 20, the first film 10 and the second film 20 are bonded to each other by means of the thermal bonding or thermal pressure bonding. The release film is not melted or softened at a temperature of the thermal bonding process and provides excellent dimensional stability while being used.

After the first film 10 and the second film 20 have been bonded to each other by means of the thermal bonding or thermal pressure bonding, the release film stacked on the other surface of the second film 20 is removed.

Next, the first film 10 and the second film 20 are cut to make the soft part 100 so that the soft part 100 has the solid shape (in the step of (e)).

In detail, the first film 10 and the second film 20 are cut to make the soft part 100, while the coupled portion where the first film 10 and the second film 20 are bonded to each other is remaining according to the shape of the filler S.

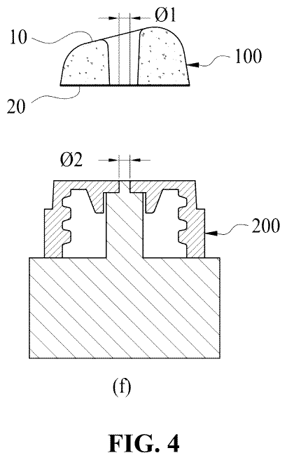

FIG. 4 is a sectional view showing the step of cutting the films if a through hole is formed on the support part in the method for manufacturing a cosmetic applicator according to the present disclosure.

Referring to FIG. 4, if the through hole from which a fluid is discharged is formed on the soft part 100 of the cosmetic applicator, a diameter Ø1 of a hollow hole formed by means of the cut of the first film 10 and the second film 20 is greater than a diameter Ø2 of a through hole formed on the support part 200 so as to reproduce an accurate numeric value in the process of coupling the soft part 100 to the support part 200. For example, if the diameter Ø2 is about 1.2 mm, the diameter Ø1 is cut to about 1.4 mm, which is greater by 0.2 mm than the diameter Ø2. As the diameter Ø1 is cut to be greater than the diameter Ø2, interference occurring upon welding (that is, ultrasonic welding) on the hollow hole can be minimized, thereby obtaining an accurate dimension of the through hole.

In this case, the hollow hole where the through hole is positioned is cut in a state where a PE film is overlaid on the outer surface of the second film 20, thereby suppressing the first film 10 and the second film 20 from being rolled or irregularly cut.

Lastly, the support part 200 is joined to the second film 20 of the soft part 100 to make the cosmetic applicator with the soft part 100 and the support part 200 (in the step of (f)).

Any one or more methods selected from heat, pressure, ultrasound, laser, and solvent are applied between the second film 20 of the soft part 100 and the support part 200, thereby joining the soft part 100 and the support part 200 together. In detail, the soft part 100 and the support part 200 are joined together by means of ultrasonic welding.

The ultrasonic welding is a technique that applies given pressure and ultrasonic vibrations to generate mechanical vibrations to the second film on the upper side and the first film on the lower side so that because of physical diffusion caused by the mechanical vibrations, the upper and lower films are joined strongly to each other.

If the support part 200 is joined to the second film 20 of the soft part 100 by means of simple pressing, a perfect contact surface between the outer surface of the second film 20 and the surface of the support part 200 is not ensured, so that the joined portion may be easily separated, which causes a product defect.

According to the present disclosure, however, vibration energy produced through ultrasounds is applied through the ultrasonic welding, while pressing is being applied, so that a rigid coupling force is applied to the bonded surface between the first film 10 and the second film 20 through the diffusion of the vibration energy in a left and right (transverse) direction.

In this case, if the support part 200 contains the same material as the second film 20, the diffusion between the films occurs effectively through the ultrasonic welding to allow the soft part 100 and the support part 200 to be rigidly joined together, thereby improving the durability of the cosmetic applicator.

The support part 200 serves to supportingly fix the soft part 100 thereto and is generally made of a hard material by means of injection molding. According to the present disclosure, the support part 200 is joined to the soft part 100 by means of the ultrasonic welding, thereby making the cosmetic applicator with the soft part 100 and the support part 200 joined together. The support part 200 reinforces the physical properties of the soft part 100 and serves as a coupler that is coupled to the cosmetic container, so that the cosmetic applicator of the present disclosure is coupled to a part such as a body of the cosmetic container and thus used. Using the method for manufacturing the cosmetic applicator of the present disclosure, therefore, the cosmetic applicator having high durability can be produced, and further, the cosmetic applicator with the soft part 100 and the support part 200 joined to each other can be made, thereby reducing the time required for the process and the manufacturing cost of the cosmetic applicator and increasing the production efficiency of the cosmetic applicator.

The method of the present invention has been described with reference to steps A, B, C, D, E and F in a particular order; however, the invention is not limited thereto. It will be apparent to those skilled in the art that the order of the steps may be varied, certain steps may be omitted, or additional steps may be added without departing from the spirit of the invention.

Further, a cosmetic applicator, which is made according to the above-mentioned method of the present disclosure, is provided according to another embodiment of the present disclosure.

The cosmetic applicator according to another embodiment of the present disclosure includes the soft part 100 and the support part 200. The soft part 100 includes the first film 10, the filler S, and the second film 20, and the first film 10 is bonded to one surface of the filler S, while the second film 20 is being bonded to the other surface of the filler S. Further, the soft part 100 has the application surface 110 formed on one surface thereof in such a way as to tilt in one direction, and the support part 200 is joined to the other surface of the soft part 100.

The first film 10 forms the application surface 110 on the soft part 100 and prevents the filler S from being deformed due to the stimulations (moisture, temperature, and pressure) of external environments occurring when the cosmetic applicator is frequently used.

The application surface 110 tilts in one direction, thereby allowing the cosmetic applicator to be used by a user, while providing a comfortable grip for the user.

The cosmetic applicator manufactured using the above-mentioned method of the present disclosure is available for application of makeup, sub blocks, medical products such as pain relief gel patches, adhesives, and other gel type fluids, but the cometic applicator of the present disclosure may not be limited necessarily thereto.

As described above, the method for manufacturing a cosmetic applicator according to the present disclosure makes use of the mold with the asymmetrical solid shape engraved therein, thereby enhancing a degree of freedom in designing the cosmetic applicator and ensuring excellent durability of the cosmetic applicator.

In addition, the method for manufacturing a cosmetic applicator according to the present disclosure allows the cosmetic applicator with the soft part and the support part joined together to be made to decrease production time and a manufacturing cost, thereby increasing a production efficiency of the cosmetic applicator.

Moreover, the method for manufacturing a cosmetic applicator according to the present disclosure allows the cosmetic applicator to provide smooth spreadability for the skin, thereby providing excellent feeling of use and allowing the cosmetic applicator to effectively apply the cosmetic to the skin.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. A method for manufacturing a cosmetic applicator, comprising the steps of:
(a) preparing a mold having a solid shape engraved therein;
(b) allowing a first film to come into close contact with an inner surface of the mold;
(c) filling a filler in the mold;
(d) allowing a second film to come into close contact with the mold to thus bond the first film and the second film to each other;
(e) cutting the first film and the second film to make a soft part; and
(f) joining a support part to the second film.

2. The method according to claim 1, wherein the solid shape has a surface tilting in one direction.

3. The method according to claim 1, wherein in the step of (b), the close contact is performed by means of vacuum suction.

4. The method according to claim 1, wherein the first film contains thermoplastic polyurethane (TPU).

5. The method according to claim 1, wherein the first film has a thickness between 30 and 70 μm.

6. The method according to claim 1, wherein the filler is at least one of silicone, polyurethan (PU), polyethylene (PE), and thermoplastic elastomer (TPE).

7. The method according to claim 1, wherein the second film contains thermoplastic polyurethane (TPU).

8. The method according to claim 1, wherein the second film has a thickness between 80 and μm.

9. The method according to claim 1, wherein in the step of (f), the joining is performed by means of ultrasonic welding.

10. The method according to claim 1, wherein the support part contains the same material as the second film.

11. The method according to claim 1, wherein if the support part has a through hole, a hollow hole is formed by cutting the first film and the second film in the step of (e), and a diameter Ø1 of the hollow hole is greater than a diameter Ø2 of the through hole formed on the support part.

12. A cosmetic applicator manufactured according to claim 1.

13. A cosmetic applicator comprising:
a soft part having a first film, a filler, and a second film; and
a support part,
wherein the first film is bonded to one surface of the filler, the second film is bonded to an other surface of the filler, the support part is joined to an other surface of the soft part, and the soft part has an application surface formed on one surface thereof in such a way as to tilt in one direction.
